(19) United States
(12) Patent Application Publication
(10) Pub. No.: US 2015/0260529 A1
(43) Pub. Date: Sep. 17, 2015

(54) REMOTE VEHICLE NAVIGATION SYSTEM PURGE

(71) Applicant: Ford Global Technologies, LLC, Dearborn, MI (US)

(72) Inventor: Peter Eric Petersen, Royal Oak, MI (US)

(73) Assignee: Ford Global Technologies, LLC, Dearborn, MI (US)

(21) Appl. No.: 14/215,507

(22) Filed: Mar. 17, 2014

(51) Int. Cl. G01C 21/26

(52) U.S. Cl. CPC G01C 21/26

(57) ABSTRACT

A vehicle includes a navigation system, a communication interface, and a processing device. The navigation system is configured to store location information. The communication interface is configured to receive a message containing a purge command from a remote server. The processing device is configured to purge the location information from the navigation system in response to receiving the purge command.

### BACKGROUND

Many aspects of operating a vehicle are customized for the user. Some customizations, such as climate control settings, give the user control over his or her comfort while other customizations, such as adjusting the seat, mirror, and steering wheel positions, are meant to help the user operate the vehicle. Additional customizations are for the user's convenience. For example, vehicles often allow the user to preset radio stations. Vehicles that include navigation systems sometimes allow the user to create an address book of, e.g., frequently visited locations which could include the user's home and place of business.

### BRIEF DESCRIPTION OF THE DRAWINGS

FIG. 1 illustrates an exemplary vehicle and system for purging location information from the vehicle's navigation system.

FIG. 2 is a block diagram of an exemplary system that be incorporated into the vehicle of FIG. 1.

FIG. 3 is a flowchart of an exemplary process that may be used to purge the location information from the vehicle of FIG. 1.

### DETAILED DESCRIPTION

To help protect a user's data, an exemplary vehicle includes a navigation system, a communication interface, and a processing device. The navigation system is configured to store location information. The communication interface is configured to receive a message containing a purge command from a remote server. The processing device is configured to purge the location information from the navigation system in response to receiving the purge command. Accordingly, if the vehicle is stolen, the thief will not be able to use the navigation system to determine where the user works or lives.

The vehicle and system shown in the FIGS. may take many different forms and include multiple and/or alternate components and facilities. The exemplary components illustrated are not intended to be limiting. Indeed, additional or alternative components and/or implementations may be used.

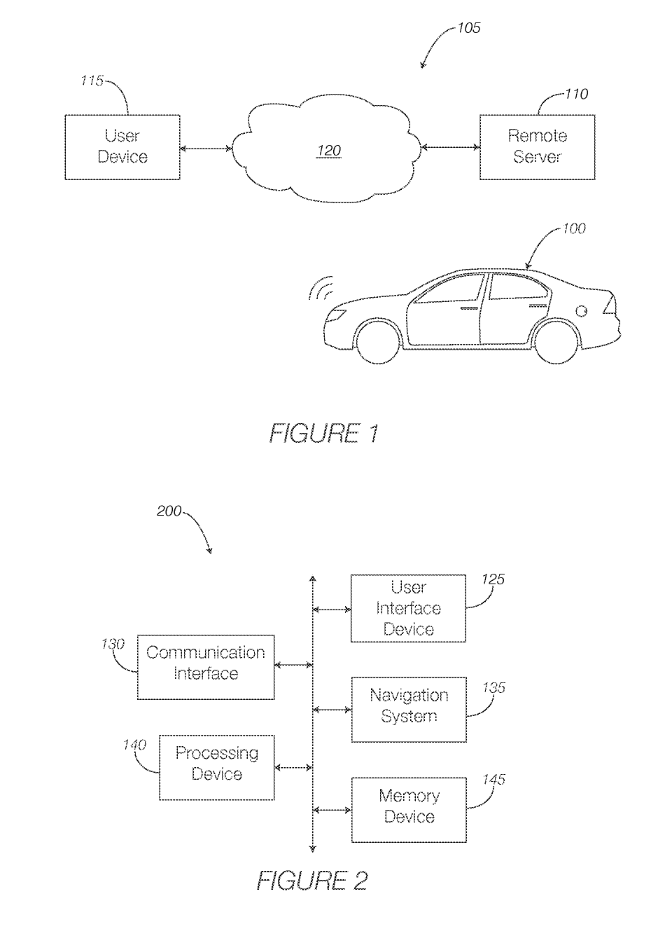

As illustrated in FIG. 1, a vehicle 100 and purge system 105 are shown. Although illustrated as a sedan, the vehicle 100 may include any passenger or commercial vehicle such as a car, a truck, a sport utility vehicle, a taxi, a bus, etc. In some possible approaches, as discussed below, the vehicle 100 is an autonomous vehicle configured to operate in an autonomous (e.g., driverless) mode, a partially autonomous mode, and/or a non-autonomous mode. The purge system 105, as shown, includes a remote server 110 in communication with a user device 115 such as a computer or mobile device. The remote server 110 may be in communication with the user device 115 over a communication network 120. The remote server 110 may be configured to receive a purge request from the user device 115. The purge request may be transmitted to the remote server 110 over the communication network 120. The remote server 110 may be configured to transmit a message to the vehicle 100. The message may include a purge command that commands the vehicle 100 to purge location information stored in the vehicle 100. The location information may identify a user's home address, work address, or other point of interest. The purge command may be transmitted over the same or different communication network 120 as the purge request. Upon receipt of the purge request, the vehicle 100 may delete the location information, as discussed in greater detail below.

FIG. 2 is a block diagram of an exemplary system 200 that may be incorporated into the vehicle 100. The system, as illustrated, include a user interface device 125, a communication interface 130, a navigation system 135, and a processing device 140.

The user interface device 125 may be configured to present information to a user, such as a driver, during operation of the vehicle 100. Moreover, the user interface device 125 may be configured to receive user inputs. Thus, the user interface device 125 may be located in the passenger compartment of the vehicle 100. In some possible approaches, the user interface device 125 may include a touch-sensitive display screen.

The communication interface 130 may be configured to facilitate wired and/or wireless communication between the components of the vehicle 100 and other devices, including the remote server 110. For instance, the communication interface 130 may be configured to receive messages from, and transmit messages to, e.g., a cellular provider's tower and the vehicle's Telematics Service Delivery Network (SDN) that, in turn, establishes communication with a user's mobile device such as a cell phone, a tablet computer, a laptop computer, a fob, or any other electronic device configured for wireless communication via a secondary or the same cellular provider. Cellular communication to the vehicle's telematics transceiver through the SDN may also be initiated from an internet connected device such as a PC, Laptop, Notebook, or WiFi connected phone. The communication interface 130 may also or alternatively be configured to communicate over the communication network 120 using any number of communication protocols such as Bluetooth®, Bluetooth® Low Energy, or WiFi. Accordingly, the communication interface 130 may be configured to receive messages transmitted from the remote server 110, including messages that include the purge command.

The navigation system 135 may be configured to determine a position of the vehicle 100, such as a current location of the vehicle 100. The navigation system 135 may include a Global Positioning System (GPS) receiver configured to triangulate the position of the vehicle 100 relative to satellites or terrestrial based transmitter towers. The navigation system 135, therefore, may be configured for wireless communication. The navigation system 135 may be further configured to develop routes from the current location to a selected destination, as well as display a map and present driving directions to the selected destination via, e.g., a user interface device 125. In some instances, the navigation system 135 may develop the route according to a user preference. Examples of user preferences may include maximizing fuel efficiency, reducing travel time, travelling the shortest distance, or the like.

The navigation system 135 may be configured to access location information from, e.g., a memory device 145. As discussed above, the location information may include various points of interest including the user's home address and business address. The navigation system 135 may be configured to access the location information from the memory device 145, select, e.g., the user's home or business address as the destination, and generate a route to the home or business address. The location information may be provided by the user via, e.g., the user interface device 125. Once input, the location information may be stored in the memory device 145 for later access and use by the navigation system 135.

The processing device 140 may be configured to process and execute the purge command received from the remote server 110. For instance, upon receipt of the purge command from the communication interface 130, the processing device 140 may be configured to delete some or all of the location information from the memory device 145. The location information that the processing device 140 may delete may include the user's home address, the user's work address, and any other personal information and/or points of interest from the memory device 145. After the location information has been deleted, the processing device 140 may encrypt the memory device 145 so that the navigation system 135, as well as all other vehicle systems or external devices, are unable to recover the deleted information. Even the processing device 140 may be unable to recover or otherwise access the deleted location information, thus protecting the user's personal information if, e.g., the vehicle 100 is stolen.

In addition to purging the location information, the processing device 140 may purge other information, such as garage door codes, that could be used to access the user's home. Therefore, if the user's vehicle 100 is stolen and the thief is able to determine the user's home address despite the purge of the location information, the thief will be unable to use the built-in garage door opener to access the user's garage, and possibly the user's home.

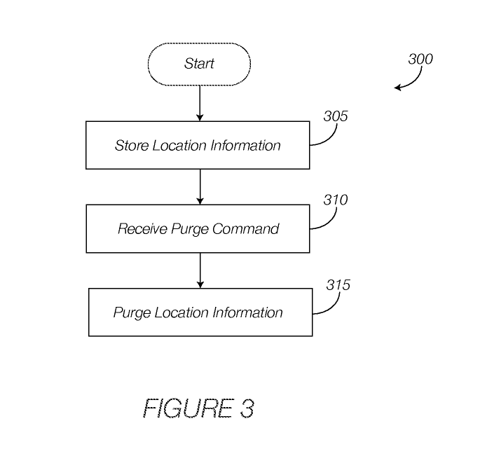

FIG. 3 is a flowchart of an exemplary process 300 that may be implemented by one or more components of the system.

At block 305, the location information may be stored in the memory device 145. The location information may be provided by a user via, e.g., the user interface device 125. As discussed above, the location information may identify a user's home address, a user's work address, and other points of interest. Once stored in the memory device 145, the location information may be accessible to other vehicle systems, such as the navigation system 135, until the location information is purged, modified, or otherwise made unavailable.

At block 310, the vehicle 100 may receive a message from the remote server 110. The message may be received by, e.g., the communication interface 130. As discussed above, the message may include a purge command. The remote server 110 may have transmitted the message in response to a purge request made by a user via, e.g., a user device 115.

At block 315, the processing device 140 may, in response to receiving the purge command, purge the location information from the memory device 145. Purging the location information may include deleting the location information from the memory device 145, and in some instances, encrypting the memory device 145 after the location information is deleted so that the memory device 145 cannot be accessed by any vehicle system, including the navigation system 135, or external devices. Thus, the navigation system 135 will be unable to access the location information and/or navigate or help someone navigate to the user's home, work, or other point of interest of importance to the user if the user's vehicle 100 is stolen. In addition, as discussed above, the processing device 140 may further purge other information, such as garage door codes, that could be used to access the user's home.

In general, computing systems and/or devices, such as the remote server 110, the user device 115, the user interface device 125, and the processing device 140, may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle comprising:
a navigation system configured to store location information;
a communication interface configured to receive a message from a remote server, the message including a purge command; and
a processing device configured to purge the location information from the navigation system in response to receiving the purge command.

2. The vehicle of claim 1, wherein the location information identifies a user's home address.

3. The vehicle of claim 1, wherein the location information identifies a user's work address.

4. The vehicle of claim 1, wherein the location information includes at least one point of interest.

5. The vehicle of claim 1, wherein the processing device is configured to purge the location information by deleting the location information from a memory device.

6. The vehicle of claim 1, wherein the processing device is configured to encrypt the memory device.

7. The vehicle of claim 6, wherein the memory device is encrypted after the location information is deleted from the memory device.

8. The vehicle of claim 1, wherein purging the location information prevents the navigation system from accessing the location information.

9. A method comprising:
storing location information in a memory device associated with a navigation system;
receiving a message from a remote server, the message including a purge command; and
purging the location information from the memory device in response to receiving the purge command.

10. The method of claim 9, wherein the location information identifies a user's home address.

11. The method of claim 9, wherein the location information identifies a user's work address.

12. The method of claim 9, wherein the location information includes at least one point of interest.

13. The method of claim 9, wherein purging the location information includes deleting the location information from the memory device.

14. The method of claim 13, wherein purging the location information includes encrypting the memory device.

15. The method of claim 14, wherein the memory device is encrypted after the location information is deleted from the memory device.

16. The method of claim 9, wherein purging the location information prevents the navigation system from accessing the location information.

17. A system comprising:
a remote server configured to receive a purge request from a user device over a communication network;
wherein the remote server is configured to transmit a message to a vehicle, the message including a purge command commanding the vehicle to purge location information from a navigation system.

18. The system of claim 17, wherein the location information identifies at least one of a user's home address and a user's work address.

19. The system of claim 1, wherein the purge command commands the vehicle to delete the location information from the navigation system.

20. The system of claim 17, wherein purging the location information prevents the navigation system from accessing the location information.
